(19) United States
(12) Patent Application Publication
(10) Pub. No.: US 2013/0112331 A1
(43) Pub. Date: May 9, 2013

(54) OFF-THE-ROAD TIRE WITH SILICA REINFORCED SIDEWALL

(71) Applicants: Dawn Michelle Johnson, Uniontown, OH (US); Paul Harry Sandstrom, Cuyahoga Falls, OH (US); Katherine Ann Folk, Uniontown, OH (US); Joseph Kevin Hubbell, Akron, OH (US)

(72) Inventors: Dawn Michelle Johnson, Uniontown, OH (US); Paul Harry Sandstrom, Cuyahoga Falls, OH (US); Katherine Ann Folk, Uniontown, OH (US); Joseph Kevin Hubbell, Akron, OH (US)

(21) Appl. No.: 13/292,246

(22) Filed: Nov. 9, 2011

(51) Int. Cl. B60C 13/00

(52) U.S. Cl. 152/525

(57) ABSTRACT

This invention relates to pneumatic rubber tires intended for use on tire sidewall engaging surfaces. In one embodiment, such rubber tire is further intended for use under heavy loaded conditions. Such tires may be referred to as off-the-road tires for use in non-highway service conditions which may include, for example, off-the-road tire, agricultural tire and industrial tire applications. Very large off-the-road tires having rim diameters of at least about 57 inches (144 cm) are a feature of this invention.

### FIELD OF THE INVENTION

This invention relates to pneumatic rubber tires intended for use on tire sidewall engaging surfaces. In one embodiment, such rubber tire is further intended for use under heavy loaded conditions. Such tires may be referred to as off-the-road tires for use in non-highway service conditions which may include, for example, off-the-road tire, agricultural tire and industrial tire applications. Very large off-the-road tires having rim diameters of at least about 57 inches (144 cm) are a feature of this invention

### BACKGROUND OF THE INVENTION

Conventionally, tires intended for use on rough ground surfaces which are tire sidewall engaging are configured with circumferential rubber treads and adjoining sidewalls supported by a tire carcass. Tires for such service are suggested, for example, in U.S. Pat. No. 6,761,198.

By the term “off-the-road”, or “off highway” tire it is meant a large tire which is intended to experience being driven over ground, other than or in addition to, paved highways, where its sidewall is subject to contact with, for example, rocks and debris. Treads for off-the-road service tires are typically comprised of a rubber composition to promote good traction and resistance to puncture.

In contrast, associated sidewalls for tires often used for large vehicular tires are conventionally not designed to be ground contacting and, in order to be appropriately supportive of the tread, are conventionally composed of a rubber composition which is not designed to emphasize traction and resistance to puncture but, instead, of a rubber composition which is softer to provide greater sidewall flexibility than that of the tread rubber.

As a result, such softer sidewall rubber compositions typically have less resistance to puncturing objects occasioned during sidewall-contacting service conditions for such tires.

For example, where large tires are desired to be utilized under relatively severe service conditions, including rough terrain, such as, for example, heavily loaded tires during off-the-road driving conditions, it is recognized that their sidewalls may experience damaging conditions by coming in contact with the ground to include, for example, rocks and debris. Such circumstances may occur, for example, for heavy hauling conditions, for various mine operations and for logging operations, as the tire is being driven over rough terrain. Under such conditions, cut growth resistance (which may also be referred to as crack growth resistance), tear resistance and puncture resistance for the sidewall are significant considerations for sidewalls of such tires.

A significant need is therefore presented for a sidewall rubber composition to promote a combination of resistance to puncture while substantially maintaining physical properties such as cut growth resistance and tear resistance. Accordingly, a challenge is presented for providing a suitable outer, visible, sidewall rubber layer for a tire which is intended for exposure to sidewall contact conditions for off-highway (off-the-road) tire service.

Historically, various tires may sometimes be provided with sidewalls with outer sidewall rubber layers designed to promote resistance to cut growth which are carbon black reinforced rubber compositions comprised of a combination of natural cis 1,4-polyisoprene rubber and cis 1,4-polybutadiene rubber.

It is appreciated that rubber reinforcing carbon blacks for reinforcement of such outer tire sidewall rubber compositions are conventionally appreciably larger particle size than reinforcing carbon blacks usually used for tire treads.

Such rubber reinforcing carbon blacks for such tires might be exemplified, for example, by having an Iodine value (ASTM D1510) in a range of about 35 to about 50 g/kg instead of a higher Iodine value of at least 90 which would be more representative of a reinforcing carbon black typically used for a tread rubber composition.

For this application, however, it is desired to provide a tire which is intended for use under sidewall ground contacting conditions (e.g. an off-the-road tire) with an outer tire rubber sidewall rubber layer of a composition comprised of a combination of natural cis 1,4-polyisoprene rubber and cis 1,4-polybutadiene rubber which promotes resistance to puncture while substantially retaining the aforesaid crack growth resistance and tear resistance for the outer tire sidewall rubber layer.

Accordingly, it is thereby desired to provide such a tire sidewall with an outer (visible) rubber layer of a rubber composition which contains large particle size rubber reinforcing carbon black and composed of a combination of natural rubber and cis 1,4-polybutadiene rubber, somewhat common to many other tire sidewall rubber compositions but, however, promotes enhanced resistance to puncturing objects.

In the description of this invention, the term “phr” relates to parts by weight of an ingredient per 100 parts by weight of rubber.

The terms “rubber” and “elastomer” are used interchangeably.

The term “Tg” relates to a glass transition temperature of an elastomer, normally and conventionally determined by a differential scanning (DSC) calorimeter with a temperature rise of 10° C. per minute as would be understood by one skilled in such art.

The term “off-the-road”, or “off-highway”, tire relates to tires intended for use on off-highway applications where the tire sidewall contacts the ground in a sense of contacting, for example, sidewall damaging rocks or rocky conditions as well as various debris, during the tire service. Such tires particularly relate to large tires having a rim diameter (e.g. bead diameter), for example, in a range of from about 25 to about 75 inches (about 64 to about 191 cm), alternately from about 49 to about 65 inches (about 124 to about 165 cm) and, alternately at least about 57 inches (at least about 144 cm).

### DISCLOSURE AND PRACTICE OF THE INVENTION

In accordance with this invention, an off-the-road pneumatic tire having a carcass with a circumferential outer rubber tread and pair of sidewalls each extending from said tread to spaced apart beads, wherein each of said sidewalls have an outer sidewall rubber layer designed to be subject to ground contacting conditions, and wherein said outer sidewall rubber layer is a rubber composition comprised of, based on parts by weight per 100 parts by weight rubber (phr),

(A) 100 phr of elastomers comprised of
(1) about 40 to about 60 phr of cis 1,4-polyisoprene natural rubber and
(2) about 40 to about 60 phr of cis 1,4-polybutadiene rubber,

(B) about 40 to about 80 phr of reinforcing filler comprised of rubber reinforcing carbon black and precipitated silica comprised of
(1) about 20 to about 40 phr of carbon black having a property consisting of an Iodine value (ASTM D1510) of about 35 to 50 g/kg and a dibutylphthalate (DBP) value (ASTM D2414) of about 115 to 130 cc/100g,
(2) about 20 to about 40 phr of precipitated silica wherein the weight ratio of said precipitated silica to said rubber reinforcing carbon black is in a range of about 1/2 to 2/2,

(C) a coupling agent having a moiety reactive with hydroxyl groups on said precipitated silica and another different moiety interactive with said elastomers, and

(D) a sulfur cure system comprised of sulfur and sulfur vulcanization accelerators consisting of from about 1 to about 2 phr of primary sulfur vulcanization accelerators (therefore exclusive of secondary sulfur cure accelerators such as for example diphenylguanidine) consisting of a combination of N-tertbutyl-2-benzothiazolesulfenamide and N—N-dicyclohexyl-2-benzothiazolesulfenamide where the weight ratio of said N—N-dicyclohexyl-2-benzothiazolesulfenamide to said N-tertbutyl-2-benzothiazolesulfenamide is in a range of from about 5/1 to about 1.5/1, alternately from about 3/1 to about 2/1.

In one embodiment, the precipitated silica has a BET surface area in a range of from about 125 to about 200 m²/g.

In one embodiment, (in contrast to said outer sidewall rubber layer) said circumferential tread is comprised of a rubber composition, based on parts by weight per 100 parts by weight rubber (phr):

(A) at least one diene based elastomer comprised of at least one rubber comprised of polymers of at least one of isoprene and 1,3-butadiene, and copolymers of styrene with at least one of isoprene and 1,3-butadiene,

(B) about 20 to about 70, alternately about 30 to about 60, phr of rubber reinforcing filler comprised of:
(1) rubber reinforcing carbon black having an Iodine value in a range of about 90 to about 145 g/kg and a DBP value in a range of about 110 to about 145 cc/100g, or
(2) a combination of precipitated silica and said rubber reinforcing carbon black.

In one embodiment, said precipitated silica is provided without a silica coupling agent.

In another embodiment, said precipitated silica is provided together with a coupling agent for said precipitated silica having a moiety reactive with hydroxyl groups (e.g. silanol groups) on said precipitated silica and another different moiety interactive with said elastomer(s).

Therefore the composition of the said tire sidewall outer rubber layer composition differs from the rubber composition of the circumferential tread rubber composition.
While the aforesaid significantly different rubber compositions for the said tire tread and for said tire sidewall outer rubber layer are a significant aspect of this invention, the description of this invention is primarily directed to the rubber composition of the said tire sidewall outer rubber layer.

As indicated, the combination of elastomers, rubber reinforcing carbon black, precipitated silica, coupling agent and particularly the accelerator combination in the cure system for the said outer sidewall composition is used to promote puncture resistance while substantially maintaining resistance to tear and cut growth.

In one aspect of the invention, the rubbers for the outer sidewall rubber layer are the natural cis 1,4-polyisoprene rubber and the cis 1,4-cis polybutadiene rubber to provide a continuous cis 1,4 polyisoprene rubber phase containing a dispersion of cis 1,4-polybutadiene rubber phase because of a relative immiscibility of the cis 1,4-polybutadiene rubber phase with the natural rubber phase. Such immiscibility is relied upon to contribute to a resistance to crack growth propagation for the sidewall composition. The relative immiscibility is primarily a result of a significant disparity (spaced apart) of the glass transition temperatures (Tg's) of the elastomers which differ by at least 30° C. For example, the cis 1,4-polybutadiene rubber has a Tg in a range of from about −100° C. to about −106° C. and the natural rubber has a Tg in a range of from about −65° C. to about −70° C. Such immiscibility phenomenon due to disparity of Tg's of various elastomers is known to those having skill in such art.

In order to promote an advantage of such disparity of Tg's for the elastomers of the sidewall outer layer rubber composition, it is preferred that the sidewall rubber composition is exclusive of other elastomer(s) with Tg's intermediate (between) the aforesaid Tg's of said 1,4-polybutadiene and cis 1,4-polybutadiene rubber, namely exclusive of other elastomers having a Tg between −70° C. and about −90° C.

Accordingly, in order to provide such a sidewall outer rubber composition for promoting both resistance to tear and resistance to crack growth, the blend of natural rubber and cis 1,4-polybutadiene rubber blend, with their aforesaid spaced apart Tg's is reinforced with a combination of said relatively large size rubber reinforcing carbon black and precipitated silica together with a coupling agent and the aforesaid cure accelerator system.

As indicated, the larger size carbon black is a carbon black conventionally used for rubber sidewalls and is in contrast to relatively small size carbon blacks conventionally used for tire tread rubber compositions. It is considered herein that a contribution of such relatively large size carbon black is to promote crack growth resistance to the sidewall rubber composition.

In particular, a precipitated silica is required by this invention to be used in combination with the larger size carbon black as reinforcement for the natural rubber/cis 1,4-polybutadiene sidewall rubber composition. It is considered herein that a significant contribution of the precipitated silica, when used with a coupling agent, is to enhance modulus (e.g.: 300 percent modulus), puncture resistance, tear resistance properties of the rubber composition while promoting a relatively low heat build up for the rubber composition.

As indicated, it is also considered that a significant aspect of this invention relates to the aforesaid sulfenamide cure accelerator combination to promote a balance of the aforementioned rubber property attributes.

Therefore, a significant aspect for the rubber sidewall of this invention for ground contacting purposes is the unique combination of specified amounts of natural rubber and cis 1,4-polybutadiene rubber with spatially defined (spaced apart) Tg's and with a specified reinforcement system of selected relatively large particle size rubber reinforcing carbon black and precipitated silica with coupling agent and specific cure accelerator combination to promote an acceptable puncture resistance while substantially maintaining cut growth resistance, tear resistance, and heat buildup physical properties.

The natural rubber for use in this invention is a cis 1,4-polyisoprene rubber typically having a cis 1,4-content in a range of about 95 to about 100 percent and the aforesaid Tg in range of about −65° C. to about −70° C.

As indicated, it is particularly important for this invention that the cis 1,4-polyisoprene rubber and cis 1,4-polybutadiene rubber for use in this invention have spaced apart Tg's, namely Tg's that differ by at least 30° C., in order that the rubbers are relatively incompatible, or immiscible, with each other in order to, for example, promote resistance to cut growth for the tire sidewall outer rubber layer.

Representative examples of such large sized rubber reinforcing carbon black for the sidewall outer rubber layer are, for example, of ASTM designations: N550, N660 and N326 rather than smaller particle sized N110, N121 and N299 carbon blacks more normally used for tread rubber compositions.

As indicated, it is desired for the carbon black reinforcement filler in the sidewall outer rubber layer to be exclusive of rubber reinforcing carbon blacks having an Iodine value (number) of 90 g/kg or greater.

As indicated the precipitated silica for use in the sidewall outer rubber layer desirably has a BET surface area in a range of from about 125 to 200 m²/kg.

Various coupling agents for the precipitated silica may be used such as, for example, bis-(3-trialkoxysilylalkyl)polysulfides which contain an average of from 2 to about 4 connecting sulfur atoms in its polysulfidic bridge, with an average of from about 3.2 to about 3.8 or an average of from about 2 to about 2.6 connecting sulfur atoms in its polysulfidic bridge, and as, for example, a coupling agent comprised of an organoalkoxymercaptosilane. Alkyl groups for the alkoxy groups desirably include ethyl groups and the alkyl group for said silylalkyl moiety may be selected from, for example, ethyl, propyl and butyl radicals, particularly propyl groups.

Accordingly, in one embodiment such bis-(3-trialkoxysilylalkyl)polysulfide coupling agent may, for example, be comprised of a bis-(3-triethoxysilylpropyl)polysulfide.

As indicated, the sulfur vulcanization accelerators are a defined combination consisting of two sulfenamide compounds, namely N—N-dicyclohexyl-2-benzothiazolesulfenamide and N-tertbutyl-2-benzothiazolesulfenamide where the weight ratio of said N—N-dicyclohexyl-2-benzothiazolesulfenamide to said N-tertbutyl-2-benzothiazolesulfenamide is in a range of from about 5/1 to about 1.5/1, alternately from about 3/1 to about 2/1 so that the N—N-dicyclohexyl-2-benzothiazolesulfenamide is in the majority. The combination of the two sulfur vulcanization accelerators is exclusive of secondary sulfur cure accelerators such as, for example, diphenylguanidine. Other accelerator types or combinations are excluded from this invention.

It is readily understood by those having skill in the art that the rubber compositions of the sidewall would be compounded by methods generally known in the rubber compounding art, such as mixing the various sulfur-vulcanizable constituent rubbers with various commonly used additive materials, were appropriate, such as, processing additives, such as oils, resins, including tackifying resins and plasticizers, fatty acid, zinc oxide, waxes, antioxidants, antiozonants and peptizing agents. As known to those skilled in the art, depending on the intended use of the sulfur vulcanizable and sulfur vulcanized material (rubber), the additives mentioned above are selected and commonly used in conventional amounts.

Typical amounts of tackifying resins, if used, may be comprised of about 0.5 to about 10 phr, usually about 1 to about 5 phr. Typical amounts of processing aids may be comprised of about 1 to 10 phr, if used. Such processing aids can include, for example, aromatic, naphthenic, and/or paraffinic processing oils. Typical amounts of antioxidants, where used, may comprise about 1 to about 3 phr. Representative antioxidants may be, for example, diphenyl-p-phenylenediamine and others, such as, for example, those disclosed in The Vanderbilt Rubber Handbook (1978), Pages 344 through 346. Typical amounts of antiozonants for the sidewall composition, where used, may comprise about 3 to about 7 phr. Representative antiozonants may be, for example, N-(1,3 dimethylbutyl)-N′-phenyl-p-phenylenediamine. Typical amounts of fatty acid, if used, which can include stearic acid comprise about 0.5 to 3 phr. Typical amounts of zinc oxide comprise about 2 to about 6 phr. Typical amounts of waxes comprise about 1 to about 5 phr. Often microcrystalline waxes are used. Typical amounts of peptizers comprise about 0.1 to about 1 phr. Typical peptizers may be, for example, pentachorothiophenol and dibenzamidodiphenyl disulfide.

The presence and relative amounts of the above additives are considered to be not an aspect of the present invention which is more primarily directed to the utilization of specified blend of natural rubber and cis 1,4-polybutadiene rubber in the tire sidewall outer rubber layer designed to be ground contacting as a sulfur vulcanizable composition which is reinforced with a specified combination of relatively large particle sized carbon black together with precipitated silica and coupling agent and specific accelerator combination of the sulfenamide type.

The vulcanization is conducted in the presence of a sulfur vulcanization agent, plus the aforesaid combination of sulfenamide sulfur cure accelerators. The sulfur vulcanization is preferably sulfur, particularly elemental sulfur which may include at least one sulfur and particularly a configuration of a plurality of connected sulfur atoms, all of which may be referred to as being elemental sulfur. The elemental sulfur may be used in an amount of, for example, from about 0.5 to about 4 phr, alternatively in a range of from about 0.5 to about 2 phr.

Sometimes, if desired, a combination of antioxidants, antiozonants and waxes may be collectively referred to as “antidegradants”. To promote ozone and oxidation protection, the said sidewall is comprised of relatively large concentrations (e.g.: about 4 to about 12 phr) of antidegradants.

For purposes of this invention, it is desired to provide a sulfur vulcanized diene-based rubber compositions which can have the following target physical properties for use in the Off-the-Road tire sidewalls outer rubber layer. Such properties are represented in Table A.

TABLE A

| Target Properties* | Physical Property Values |
|---|---|
| Energy penetration, joules | at least 3 and desirably in a range of |
| | from 3 to about 5 |
| Tear Resistance at 95° C., | at least 150 and desirably in a range of |
| Newtons | from 150 to about 325 |
| Crack Growth Rate, minutes/mm | at least 100, and desirably in a range of |
| | from about 100 to about 200 |
| Tangent Delta at 100° C. and | at most 0.17, and desirably in a range of |
| 1 hertz, 10% strain | from about 0.1 to about 0.17 |
| T90, or time to 90% of cure at | at least 60, and desirably in a range of |
| 135° C., in minutes | from about 60 to about 75 |

*Test conditions are described in Table 2 footnotes.

The following Examples are presented to further illustrate the invention. Parts and percentages are by weight unless otherwise indicated.

### EXAMPLE I

Rubber Sample A relates to a generalized tire sidewall rubber composition and rubber Sample B relates to a generalized tire tread rubber composition. The generalized materials for the rubber Samples A and B, in parts per hundred rubber (phr), are illustrated in Table 1.

TABLE 1

| | Sidewall | Tread |
|---|---|---|
| Materials | A | B |
| Cis 1,4-polyisoprene rubber¹ | 50 | 100 |
| Cis 1,4-polybutadiene rubber² | 50 | 0 |
| Reinforcing filler³ | 50 | 50 |
| Processing additives⁴ | 15 | 6 |
| Protectants⁵ | 6 | 5 |
| Cure System⁶ | 7 | 11 |

¹Natural cis 1,4-polyisoprene rubber
²Cis 1,4-polybutadiene rubber
³Rubber reinforcing carbon black and precipitated silica without silica coupler. Larger particle sized rubber reinforcing carbon black as N550 (ASTM designation) for the Sidewall rubber composition and smaller sized rubber reinforcing carbon black as N347 for the Tread rubber composition.
⁴Processing oil, together with resins where appropriate
⁵Antidegradants
⁶Cure System includes: sulfur and sulfenamide accelerators and zinc oxide and fatty acid comprised of stearic, palmitic and oleic acids.

The physical properties for rubber Samples A and B are illustrated in Table 2. Where appropriate, the Samples in Table 2 were cured at a temperature of about 135° C. for about 140 minutes.

TABLE 2

| | Target | Side- | Tread |
|---|---|---|---|
| Properties | Properties | wall A | B |
| Energy of penetration¹, joules | 3 to 5 | 2 | 4.9 |
| Tear resistance at 95° C.², Newtons | 150 to 325 | 252 | 204 |
| Crack growth rate³, minutes per mm | 100 to 200 | 126 | 31 |
| Tangent delta⁴ at 100° C. and 1 hertz, | 0.1 to 0.17 | 0.17 | 0.1 |
| 10% strain | | | |
| T90, or time to 90% of cure⁵, at 135° C., | 60 to 75 | 65 | 45 |
| in minutes | | | |

¹Energy Penetration: Test performed on vulcanized rubber at about 25° C. and can be described as a 45° angle, 4.8 mm diameter indentor driven into a rubber sample block at constant speed of about 100 mm/minute. Energy to penetrate to 20 mm depth is noted. A higher value is better to resist penetrating objects. See FIG. 1 for a graphical plot of energy in joules versus of depth of puncture in millimeters
²Tear Resistance: Test performed on vulcanized rubber at about 95° C. and is the force required to pull apart 5 mm wide strips (180° pull). It is a measure of interfacial adherence to itself. A higher value is better.
³Crack Growth Rate: Test performed on vulcanized rubber at about 95° C. and can be described as repeated bend flexing of a sample at about 320 cycles/minute, for a total test time of 240 minutes. Crack length is measured at timed intervals and recorded. A higher value indicates a longer time to grow the cut which is better. See FIG. 2 for a graphical plot of crack growth length in terms of millimeters versus time in minutes.
⁴Tangent Delta: Test performed on vulcanized rubber using Rubber Process Analyzer. A sealed and pressurized die cavity contains the sample during testing. Sample is cured to about 135° C. for about 140 minutes. Storage and loss modulii (G′ and G″) are measured for programmed strains between about 1 percent and 140 percent, at about 1 Hertz frequency and testing controlled at about 100° C. Tangent delta at 10 percent strain is the result of G″ at 10 percent strain divided by G′ at 10 percent strain. A lower value indicates lower heat buildup properties, i.e. lower hysteresis.
⁵Rheometer: Torque applied by moving die to uncured rubber sample which cures during test at about 135° C. for about 140 minutes. The time in minutes to reach 90 percent of cure amount, for given test duration is calculated.

It can be seen from Table 2 that the generalized tire sidewall Sample A does not meet the desired penetration energy and therefore has less resistance to puncturing objects. In general the sidewall is designed to be softer which provides greater flexibility than tread rubber. This softer rubber component leads to higher tear resistance and crack growth resistance and higher heat buildup properties versus the generalized tire tread Sample B.

Conversely, it can be seen in Table 2 that the generalized tire tread Sample B which is designed for traction and puncture resistance does meet the desired penetration energy, but the tread rubber has less resistance to crack growth. The cure rate for the tire tread reaches 90% of cure amount faster than the sidewall and therefore does not meet the desired cure rate target.

### EXAMPLE II

Rubber compositions comprised of mixtures of natural cis 1,4-polyisoprene rubber having a Tg of about −65° C. to about −70° C. and cis 1,4-polybutadiene rubber having a Tg of about −100° C. to about −106° C. together with N550 rubber reinforcing carbon black and precipitated silica were prepared which are referred herein as Control rubber Sample C and Experimental rubber Sample D. Control rubber Sample C is a known sidewall formulation referenced in U.S. Pat. No. 6,046,266.

Ingredients for the rubber Samples C and D, in parts per hundred rubber (phr), are illustrated in Table 3.

TABLE 3

| | | |
|---|---|---|
| | Control | Exp'l |
| Materials | C | D |

Non-Productive Mixing Stage (NP)

| | | |
|---|---|---|
| Natural rubber¹ | 50 | 50 |
| Cis 1,4-polybutadiene rubber² | 50 | 50 |
| Carbon black³ | 30 | 30 |
| Silica (precipitated silica)⁴ | 30 | 30 |
| Coupling agent composite⁵ | 5 | 5 |
| Processing aids (oils and resins) | 7 | 8 |
| Antidegradant (amine based) | 4 | 4 |
| Wax (microcrystalline/paraffinic mixture) | 1.5 | 1.5 |
| Zinc oxide | 2 | 2 |
| Fatty acid (stearic, palmitic and oleic acids) | 1 | 0.5 |

Productive Mixing Stage (P)

| | | |
|---|---|---|
| Sulfur cure accelerator A⁶ | 0 | 1 |
| Sulfur cure accelerator B⁷ | 1.45 | 0.45 |
| Ratio of accelerator A to accelerator B | 0/1.45 | 2.2/1 |
| Sulfur | 1.5 | 1.5 |
| Antidegradant (amine based) | 1.3 | 1.3 |

¹Natural cis 1,4-polyisoprene rubber having a Tg of about −65° C. to −70° C.
²Cis 1,4-polybutene rubber as Budene ™ 1207 from The Goodyear Tire & Rubber Company having a cis 1,4 isometric configuration content of about 99 percent and a Tg of about −103° C.
³N550, an ASTM designation, with an Iodine Number of about 43 g/kg and a DBP value of about 121 cc/100 g
⁴Precipitated silica as HiSil 210 ™ from PPG having a BET (nitrogen) surface area of about 135 m²/g
⁵Coupling agent comprised of bis (3-triethoxysilylpropyl) polysulfide having an average in a range of about 2 to about 2.6 sulfur atoms in its polysulfidic bridge and carbon black in a 50/50 weight ratio as X266s ™ from Degussa Evonik
⁶N-N-dicyclohexyl-2-benzothiazolesulfenamide
⁷N-tertbutyl-2-benzothiazolesulfenamide

The physical properties for rubber Samples C and D are illustrated in Table 4. Where appropriate, the Samples in Table 4 were cured at a temperature of about 135° C. for about 140 minutes.

TABLE 4

| | Target | Control | Exp'l |
|---|---|---|---|
| Properties* | Properties | C | D |
| Energy of penetration, joules | 3 to 5 | 4.1 | 3.6 |
| Tear 4esistance at 95° C., Newtons | 150 to 325 | 138 | 305 |
| Crack growth rate, minutes per mm | 100 to 200 | 80 | 152 |
| Tangent delta at 100° C. and 1 hertz, | 0.10 to 0.17 | 0.13 | 0.14 |
| 10% strain | | | |
| T90, or time to 90% of cure at 135° C., | 60 to 75 | 34 | 72 |
| in minutes | | | |

*Test conditions are described in Table 2 footnotes.

From Table 4 it can be seen that Control Sample C, with a single cure accelerator (shown in Table 3) does not meet the criteria of this invention. Sample C has improved penetration resistance and low heat build up properties, but tear resistance and crack growth resistance are lower than desired target properties and the time to achieve 90% of cure is two times faster than the desired target. Rubber Sample D having a combination of sulfenamides meets all five desired target properties.

### EXAMPLE III

Additional rubber Samples E and F were evaluated to determine whether a certain ratio of sulfenamides is required to achieve the desired target properties versus those reported for rubber Samples C and D in Example II. The additional rubber Samples E and F were the same as rubber Sample D except the sulfenamide sulfur cure accelerator amounts in parts per hundred rubber (phr) were varied as seen in Table 5.

TABLE 5

| | Control | Exp'l | Exp'l | Exp'l |
|---|---|---|---|---|
| | C | D | E | F |
| Sulfur cure accelerator A¹ | 0 | 1 | 0.75 | 0.45 |
| Sulfur cure accelerator B² | 1.45 | 0.45 | 0.75 | 1 |
| Ratio of accelerator A to B | 0/1.45 | 2.2/1 | 1/1 | 1/2.2 |

¹Accelerator A = N-N-dicyclohexyl-2-benzothiazolesulfenamide
²Accelerator B = N-tertbutyl-2-benzothiazolesulfenamide

The physical properties for rubber Samples E and F are compared with rubber Samples C and D and are illustrated in Table 6. Where appropriate, the Samples were cured at a temperature of about 135° C. for about 140 minutes.

TABLE 6

| | Target | Control | Exp'l | Exp'l | Exp'l |
|---|---|---|---|---|---|
| Properties* | Properties | C | D | E | F |
| Energy of penetration, joules | 3 to 5 | 4.1 | 3.6 | 5 | 4.3 |
| Tear resistance at 95° C., Newtons | 150 to 325 | 138 | 305 | 219 | 141 |
| Crack growth rate, minutes per mm | 100 to 200 | 80 | 152 | 44 | 55 |
| Tangent delta at 100° C. and 1 hertz, | 0.10 to 0.17 | 0.13 | 0.14 | 0.16 | 0.14 |
| 10% strain | | | | | |
| T90, or time to 90% of cure at 135° C., | 60 to 75 | 34 | 72 | 46 | 4 |
| in minutes | | | | | |

*Test conditions are described in Table 2 footnotes.

From Table 6 it can be seen that rubber Samples E and F with the identified cure accelerator ratios (shown in Table 5) have substantially faster crack growth rate and have a faster cure rate than rubber Sample D. Therefore it can be seen that the specific cure accelerator ratio of 2.2 to 1 of said N—N-dicyclohexyl-2-benzothiazolesulfenamide to said N-tertbutyl-2-benzothiazolesulfenamide with N—N-dicyclohexyl-2-benzothiazolesulfenamide in the majority meets all the desired target properties which is a significant aspect of this invention.

The following Tables 7 and 8 are presented to report data for rubber Samples A through F to provide a graphical presentation of Penetration Energy in Joules versus Penetration Depth in mm for FIG. 1 herein and Crack Growth Length in terms of millimeters, mm, versus Time in minutes for FIG. 2 herein in a sense of supplementing data reported in Tables 2, 4 and 6.

TABLE 7
Penetration Energy in Joules

| | Sidewall | Tread | Control | Exp'l | Exp'l | Exp'l |
|---|---|---|---|---|---|---|
| Penetration Depth, mm | A | B | C | D | E | F |
| Five (5) | 0.07 | 0.12 | 0.14 | 0.12 | 0.18 | 0.14 |
| Ten (10) | 0.38 | 0.73 | 0.77 | 0.67 | 0.93 | 0.79 |
| Fifteen (15) | 0.99 | 2.08 | 2.04 | 1.80 | 2.45 | 2.12 |
| Twenty (20) | 2.04 | 4.58 | 4.08 | 3.61 | 4.96 | 4.34 |

TABLE 8
Crack Growth in mm

| | Side- | Tread | Con- | Exp'l | Exp'l | Exp'l |
|---|---|---|---|---|---|---|
| Time, minutes | wall A | B | trol C | D | E | F |
| Fifteen (15) | 2.7 | 5.6 | 6.3 | 3.4 | 5.5 | 4.7 |
| Thirty (30) | 3 | 7.7 | 7.5 | 4 | 7.2 | 6.9 |
| Sixty (60) | 3.6 | 11.3 | 8.1 | 4.1 | 9 | 8.4 |
| One hundred twenty (120) | 3.8 | 13.7 | 8.1 | 4.4 | 9.4 | 8.6 |
| One hundred eighty (180) | 4.1 | 14.8 | 8.2 | 4.4 | 9.4 | 8.6 |
| Two hundred forty (240) | 4.3 | 15.6 | 8.2 | 4.4 | 9.5 | 8.7 |

The following drawings are presented for further understanding of the rubber Sample results shown in Tables 7 and 8.

### BRIEF DESCRIPTION OF DRAWINGS

FIG. 1 is a graphical presentation of penetration energy versus depth of penetration for each of cured rubber Samples A through F.

FIG. 2 is a graphical presentation of crack growth length versus time for each of cured rubber Samples A through F.

### THE DRAWINGS

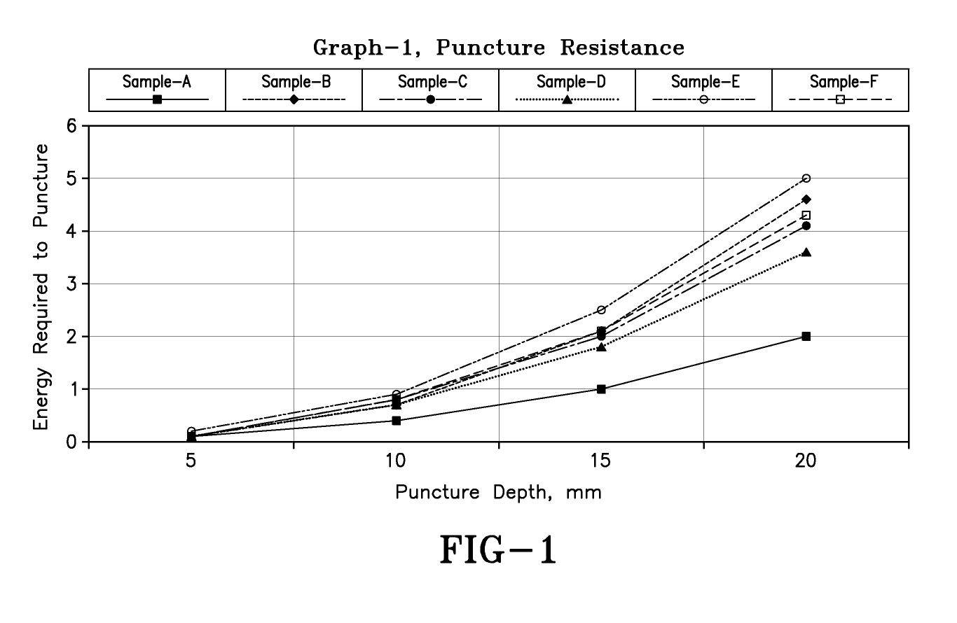

It is recalled that rubber Sample D fulfilled all of the indicated parameters shown in Table A, where rubber Sample D utilized a combination of sulfur vulcanization accelerators, namely N—N-dicyclohexyl-2-benzothiazolesulfenamide (accelerator A) and N-tertbutyl-2-benzothiazolesulfenamide (accelerator B) where the weight ratio of said N—N-dicyclohexyl-2-benzothiazolesulfenamide to said N-tertbutyl-2-benzothiazolesulfenamide is 2.2/1 so that the N—N-dicyclohexyl-2-benzothiazolesulfenamide (accelerator A) is in the majority. In FIG. 1 energy, in terms of joules, to penetrate cured rubber Samples A through F are plotted versus depth of puncture in terms of millimeters (mm).

It can graphically be seen from FIG. 1 that the penetration energy reported in Table 7 for Sidewall Sample A required less energy (joules) to penetrate, i.e. less resistant to puncture, than for Tread Sample B and Experimental Samples C, D, E and F. From Table 2 it was previously stated that the generalized tire tread has better puncture resistance than the tire sidewall. Experimental Samples C, D, E and F having the same formulation with exception to the ratio of sulfur cure accelerators exhibit increased energy to penetrate which is predictive of improved puncture resistance.

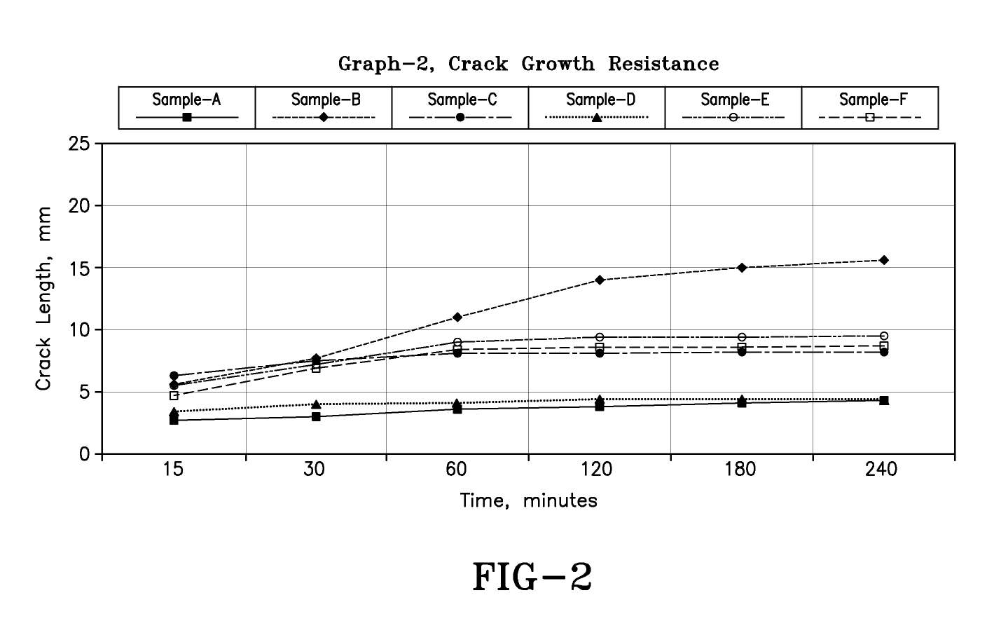

In FIG. 2 cut growth length (crack growth length), in terms of millimeters, to cut cured rubber Samples A through F are plotted against time, in terms of minutes.

It can graphically be seen from FIG. 2 that Sidewall Sample A and Experimental Sample D take the longest time for the crack to propagate versus Tread Sample B and Experimental Samples C, E and F which is predictive of improved crack growth resistance. It was previously stated from Table 2 that the generalized tire sidewall has higher resistance to crack growth than the generalized tire tread. Although Experimental Samples C, D, E and F have similar formulations, Sample D with the specific weight ratio of said N—N-dicyclohexyl-2-benzothiazolesulfenamide to said N-tertbutyl-2-benzothiazolesulfenamide of 2.2/1 so that the N—N-dicyclohexyl-2-benzothiazolesulfenamide is in the majority takes longer for a crack to grow versus Experimental Samples C, E and F.

From the graphical displays in FIGS. 1 and 2, Experimental Sample D is the only sample to meet both desired properties of puncture resistance and crack growth resistance, while meeting other critical properties of tear resistance, low heat build up and time to reach 90% of cure amount.

For convenience, the following Table 9 presents a summary of physical property results for rubber Samples A through F.

TABLE 9

| | Desired | Sidewall | Tread | Control | Exp'l | Exp'l | Exp'l |
|---|---|---|---|---|---|---|---|
| Target Properties | Range | A | B | C | D | E | F |
| Cure accelerator A (phr)¹ | — | — | — | 0 | 1 | 0.75 | 0.45 |
| Cure accelerator B (phr)² | — | — | — | 1.45 | 0.45 | 0.75 | 1 |
| Ratio of accelerator A to B | — | — | — | 0/1.45 | 2.2/1 | 1/1 | 1/2.2 |
| Energy penetration, joules | 3 to 5 | 2 | 4.9 | 4.1 | 3.6 | 5 | 4.3 |
| Tear 4esistance, N | 150 to 325 | 252 | 204 | 138 | 305 | 219 | 141 |
| Crack growth rate, min/mm | 100 to 200 | 126 | 31 | 80 | 152 | 44 | 55 |
| Tangent delta at 10% strain | 0.10 to 0.17 | 0.17 | 0.10 | 0.13 | 0.14 | 0.16 | 0.14 |
| Time to 90% of cure, min | 60 to 75 | 65 | 45 | 34 | 72 | 46 | 45 |

¹Accelerator A = N-N-dicyclohexyl-2-benzothiazolesulfenamide
²Accelerator B = N-tertbutyl-2-benzothiazolesulfenamide

From Table 9 it can be seen that rubber Sample D, with its sulfur cure accelerators limited to a combination of the sulfenamide based sulfur cure accelerators having a ratio of 2.2/1 of accelerator A to accelerator B, met all of the indicated challenged physical properties identified in Table A

While the present invention has been illustrated by the description of one or more embodiments thereof, they are not intended to restrict or limit the scope of the appended claims to such detail. Additional advantages and modifications will readily appear to those skilled in the art.

What is claimed is:

1. An off-the-road pneumatic tire having a carcass with a circumferential outer rubber tread and pair of sidewalls each extending from said tread to spaced apart beads, wherein each of said sidewalls have an outer sidewall rubber layer designed to be subject to ground contacting conditions, and wherein said outer sidewall rubber layer is a rubber composition comprised of, based on parts by weight per 100 parts by weight rubber (phr),
(A) 100 phr of elastomers comprised of
(1) about 40 to about 60 phr of cis 1,4-polyisoprene natural rubber and
(2) about 40 to about 60 phr of cis 1,4-polybutadiene rubber,
(B) about 40 to about 80 phr of reinforcing filler comprised of rubber reinforcing carbon black and precipitated silica comprised of
(1) about 20 to about 40 phr of carbon black having a property consisting of an Iodine value (ASTM D1510) of about 35 to 50 g/kg and a dibutylphthalate (DBP) value (ASTM D2414) of about 115 to 130 cc/100g, and
(2) about 20 to about 40 phr of precipitated silica wherein the weight ratio of said precipitated silica to said rubber reinforcing carbon black is in a range of about 1/2 to 2/2,
(C) a coupling agent having a moiety reactive with hydroxyl groups on said precipitated silica and another different moiety interactive with said elastomers, and
(D) a sulfur cure system comprised of sulfur and sulfur vulcanization accelerators consisting of from about 1 to about 2 phr of primary sulfur vulcanization accelerators consisting of a combination of N-tertbutyl-2-benzothiazolesulfenamide and N—N-dicyclohexyl-2-benzothiazolesulfenamide where the weight ratio of said N—N-dicyclohexyl-2-benzothiazolesulfenamide to said N-tertbutyl-2-benzothiazolesulfenamide is in a range of from about 5/1 to about 1.5/1.

2. The tire of claim 1 wherein where the weight ratio of said N—N-dicyclohexyl-2-benzothiazolesulfenamide to said N-tertbutyl-2-benzothiazolesulfenamide is in a range of from about 3/1 to about 2/1.

3. The tire of claim 1 having rim diameter in a range of from about 25 to about 75 inches (about 64 to about 191 cm).

4. The tire of claim 1 having a rim diameter in a range of from about 49 to about 65 inches (about 124 to about 165 cm).

5. The tire of claim 1 having a rim diameter of at least about 57 inches (at least about 144 cm).

6. The tire of claim 1 wherein said circumferential tread is a rubber composition comprised of, based on parts by weight per 100 parts by weight rubber (phr):
(A) at least one diene based elastomer comprised of at least one rubber comprised of polymers of at least one of isoprene and 1,3-butadiene, and copolymers of styrene with at least one of isoprene and 1,3-butadiene, and
(B) about 20 to about 70 phr of rubber reinforcing filler comprised of:
(1) rubber reinforcing carbon black having an Iodine value in a range of about 90 to about 145 g/kg and a DBP value in a range of about 110 to about 145 cc/100g, or
(2) a combination of precipitated silica and said rubber reinforcing black.

7. The tire of claim 1 wherein, said rubber composition of said sidewall outer rubber layer is comprised of a continuous phase of said natural cis 1,4-polyisoprene rubber containing a dispersed discontinuous phase of said cis 1,4-cis polybutadiene rubber.

8. The tire of claim 1 wherein said natural cis 1,4-polyisoprene rubber has a Tg in a range of from about −65° C. to about −70° C. and said cis 1,4-polybutadiene rubber has a Tg in a range of from about −100° C. to about −106° C.

9. The tire of claim 1 wherein said sidewall outer rubber composition is exclusive of other elastomer(s) having a Tg between −70° C. and about −90° C.

10. The tire of claim 1 wherein said precipitated silica has a BET surface area of about 125 to about 200 m²/g.

11. The tire of claim 1 wherein said coupling agent is comprised of a bis-(3-trialkoxysilylalkyl)polysulfide which contains an average of from 2 to about 4 connecting sulfur atoms in its polysulfidic bridge.

12. The tire of claim 1 wherein said coupling agent is comprised of a bis-(3-trialkoxysilylalkyl)polysulfide with an average of about 3.2 to about 3.8 or an average of from about 2 to about 2.6 connecting sulfur atoms in its polysulfidic bridge.

13. The tire of claim 12 wherein said bis-(3-trialkoxysilylalkyl)polysulfide is comprised of bis-(3-triethoxysilylpropyl)polysulfide.

14. The tire of claim 1 wherein said coupling agent is comprised of an organoalkoxymercaptosilane.

15. The tire of claim 1 wherein:
(A) the weight ratio of said N—N-dicyclohexyl-2-benzothiazolesulfenamide to said N-tertbutyl-2-benzothiazolesulfenamide is in a range of from about 3/1 to 2/1,
(B) said tire has a rim diameter in a range of from about 25 to about 75 inches (about 64 to about 191 cm),
(C) the said rubber composition of said sidewall outer rubber layer is comprised of a continuous phase of said natural cis 1,4-polyisoprene rubber containing a dispersed discontinuous phase of said cis 1,4-cis polybutadiene rubber,
(D) said natural cis 1,4-polyisoprene rubber has a Tg in a range of from about −65° C. to about −70° C. and said cis 1,4-polybutadiene rubber has a Tg in a range of from about −100° C. to about −106° C. and said sidewall outer rubber composition is exclusive of elastomer(s) having a Tg of from about −70° C. to about −90° C., and
(E) wherein said coupling agent is comprised of:
(1) bis-(3-triethoxysilylpropyl)polysulfide which contains an average of from 2 to about 4 connecting sulfur atoms in its polysulfidic bridge, or
(2) an organoalkoxymercaptosilane.

16. The tire of claim 15 wherein said bis-(3-triethoxysilylpropyl)polysulfide coupling agent contains an average of from 2 to about 2.6 connecting sulfur atoms in its polysulfidic bridge.

17. The tire of claim 15 wherein said bis-(3-triethoxysilylpropyl)polysulfide coupling agent contains an average of from about 3.2 to about 3.8 connecting sulfur atoms in its polysulfidic bridge.

18. Tire of claim 6 wherein the reinforcing filler for the rubber composition of said circumferential tread is exclusive of reinforcing filler comprised of silica.

19. The tire of claim 6 wherein the reinforcing filler is a combination of said rubber reinforcing carbon black and precipitated silica without a silica coupling agent.

20. The tire of claim 6 wherein the reinforcing filler is a combination of said rubber reinforcing carbon black and precipitated silica together with a coupling agent for said precipitated silica having a moiety reactive with hydroxyl groups on said precipitated silica and another different moiety interactive with said elastomer(s).
